(19) United States
(12) Patent Application Publication
(10) Pub. No.: US 2014/0318774 A1
(43) Pub. Date: Oct. 30, 2014

(54) High Pressure, High Temperature Gravel Pack Carrier Fluid with Extended Dynamic Stability for Alternate Flow Path

(71) Applicant: HALLIBURTON ENERGY SERVICES, INC., Houston, TX (US)

(72) Inventors: Prerana Umesh Suryawanshi, Pune (IN); Achala Vasudev Danait, Pune (IN); Maxime Philippe Coffin, Pau (FR)

(73) Assignee: Halliburton Energy Services, Inc., Houston, TX (US)

(21) Appl. No.: 13/869,207

(22) Filed: Apr. 24, 2013

(51) Int. Cl. C09K 8/57

(52) U.S. Cl. CPC C09K 8/57
USPC 166/276; 507/200

(57) ABSTRACT

Fluids with high carrying capacity for particulates in high pressure environments that may also be high temperature environments may include a viscosified base fluid having a density of about 14 ppg to about 20 ppg and comprises an aqueous fluid, a salt, a gelling agent, and an oxygen scavenger. Such fluids may be utilized in methods that involve providing a sand control screen assembly disposed within a wellbore penetrating a subterranean formation; and forming a gravel pack proximal to the sand control screen assembly with a treatment fluid, wherein the treatment fluid comprises the viscosified base fluid and a plurality of particulates.

### BACKGROUND

The present invention relates to fluids with high carrying capacity for particulates in high pressure environments that may also be high temperature environments, including methods relating thereto, especially methods that involve downhole tools with alternate flow paths (e.g., shunt tubes).

Synthetic polymers and biopolymers have been used to alter the viscosity and rheology of aqueous solutions and are typically used in drilling, completion, and remedial operations in subterranean formations. Among other uses, the polymers may be used as a part of fracturing fluids for hydraulic fracturing, to viscosify drilling fluids, to control fluid loss, as blocking gels, as a part of gravel packing fluids, and the like.

Of particular note, viscosified treatment fluids may be utilized in conjunction with forming particulate packs (e.g., gravel packs) in a wellbore, a subterranean formation, or both. In such operations, the particulates are included in the viscosified treatment fluids at a concentration to allow for pumpability and particulate suspension. If the viscosified treatment fluid loses its viscosity downhole, the particulates may fall out of suspension and be deposited in an undesirable location. This deposition of particles may be more pronounced in narrow flow paths (e.g., wellbore tools with alternate flow paths, shunt tubes, and nozzles).

A treatment fluid can suffer viscosity reduction and eventually complete viscosity loss under certain subterranean conditions, e.g., high shear (e.g., caused by the pumping and placement of the viscosified treatment fluid), high temperatures (e.g., bottom hole static temperature), high formation pressures, high salinity (e.g., use of a high density brine), and low pH. Under such conditions, the polymeric material used to viscosify the treatment fluid may degrade rather quickly and lose its viscosifying properties. Relative to temperature, for example, many heteropolysaccharides are ineffective at temperatures above about 175° F. Relative to salinty, treatment fluids typically utilize salt to increase the density of the fluid, which in turn reduces the viscosity of the fluid.

Accordingly, there is a need for a viscosifying agent that provides stable, high density treatment fluid with high particulate carrying capacity under static conditions at elevated temperatures while being capable of shear thinning.

### SUMMARY OF THE INVENTION

The present invention relates to fluids with high carrying capacity for particulates in high pressure environments that may also be high temperature environments, including methods relating thereto, especially methods that involve downhole tools with alternate flow paths (e.g., shunt tubes).

One embodiment of the present invention is a method that involves providing a sand control screen assembly disposed within a wellbore penetrating a subterranean formation; and forming a gravel pack proximal to the sand control screen assembly with a treatment fluid, wherein the treatment fluid comprises a viscosified base fluid and a plurality of particulates, the viscosified base fluid having a density of about 14 ppg to about 20 ppg and comprises an aqueous fluid, a salt, a gelling agent, and an oxygen scavenger.

Another embodiment of the present invention is a method that involves forming a particulate pack in a subterranean formation, a wellbore penetrating the subterranean formation, or both with a treatment fluid, wherein the treatment fluid comprises a plurality of particulates and a viscosified base fluid, the viscosified base fluid having a density of about 14 ppg to about 20 ppg and comprising a brine, a gelling agent, and an oxygen scavenger.

Yet another embodiment of the present invention is a method that involves placing a sand control screen assembly in an uncased wellbore penetrating a subterranean formation, the sand control screen assembly comprising alternate flow paths, and the uncased wellbore having drilling fluid disposed therein; displacing the drilling fluid with a displacement fluid, the displacement fluid comprises a first viscosified base fluid having a density of about 14 ppg to about 20 ppg and comprising a brine, a gelling agent, and an oxygen scavenger; and forming a gravel pack proximal to the sand control screen assembly with a treatment fluid, wherein the treatment fluid comprises a plurality of particulates and a second viscosified base fluid, the second viscosified base fluid having a density of about 14 ppg to about 20 ppg and comprising a brine, a gelling agent, and an oxygen scavenger.

Another embodiment of the present invention is a treatment fluid that includes a plurality of particulates; a viscosified base fluid that comprises an aqueous fluid, a salt, a gelling agent, and an oxygen scavenger; wherein the viscosified base fluid has a density of about 14 ppg to about 20 ppg; and wherein the viscosified base fluid has at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 1 cp to about 10 cP measured at a shear rate of 511 s⁻¹ after conditioning at 285° F. for 48 hours, and (4) a particulate settling value of about 20% or less after conditioning at 285° F. for 30 minutes.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates two samples with different particulate settling values, and the height of the clear fluid used in calculating the particulate settling values.

### DETAILED DESCRIPTION

The present invention relates to fluids with high carrying capacity for particulates in high pressure environments that may also be high temperature environments, including methods relating thereto, especially methods that involve downhole tools with alternate flow paths (e.g., shunt tubes).

The viscosified base fluids described herein may provide for treatment fluids with a particulate carrying capacity at higher bottom hole static temperatures (e.g., about 285° F.) and high density treatment fluids (e.g., a 15 ppg cesium formate brine), which are conditions not previously achieved, especially with biopolymers. That is, the viscosified base fluids described herein may have rheological properties that remain above a desired level for a desired amount of time (e.g., to effectively place a particulate pack in a downhole operation) with the viscosified base fluid having a high density and the subterranean formation having an elevated temperature. Such properties may be especially useful in conjunction with placing particulate packs in conjunction with a sand control screen assembly (or other downhole tool) that has alternate flow paths like shunt tubes.

It should be noted that when “about” is provided at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, the treatment fluids described herein comprise a viscosified base fluid having a density of about 14 pounds per gallon (“ppg”) to about 20 ppg and comprising an aqueous fluid, a salt, an oxygen scavenger, and a gelling agent. In some embodiments, the viscosified base fluids described herein may have a density ranging from a lower limit of about 14 ppg, 15 ppg, or 17 ppg to about 20 ppg, 19 ppg, or 17 ppg, and wherein the density may range from any lower limit to any upper limit and encompasses any subset therebetween.

In some embodiments, the viscosified base fluids described herein may have properties that allow for a high carrying capacity of particulates. Examples of fluid properties of interest may include, but are not limited to, the apparent viscosity, the static viscosity, the particulate settling value, and any combination thereof, which may be measured after conditioning the viscosified base fluid so as to simulate the exposure to elevated temperatures and elevated pressures when used downhole, as described further herein.

In some embodiments, the viscosified base fluids described herein may have an apparent viscosity ranging from a lower limit of about 50 cP, 75 cP, 100 cP, or 125 cP to an upper limit of about 250 cP, 225 cP, 200 cP, or 175 cP measured at a shear rate of 100 s⁻¹ after conditioning at 285° F. for 16 hours, and wherein the apparent viscosity after such conditioning may range from any lower limit to any upper limit and encompasses any subset therebetween. The viscosified base fluids described herein may, in some embodiments, be non-Newtonian fluids with a lower viscosity at high shear rate (e.g., 100 s⁻¹) and higher viscosity at low shear rate. In some embodiments, the viscosified base fluids described herein may have an apparent viscosity ranging from a lower limit of about 100 cP, 125 cP, or 150 cP to an upper limit of about 225 cP, 200 cP, or 175 cP measured at a shear rate of 100 s⁻¹ after conditioning at 285° F. for 16 hours, and wherein the apparent viscosity after such conditioning may range from any lower limit to any upper limit and encompasses any subset therebetween. The apparent viscosity, as described herein, is preferably measured with a B5 bob (available from Fann Instrument Co.) at the described shear rate.

In some embodiments, the viscosified base fluids described herein may have a static viscosity ranging from a lower limit of about 10 cP, 20 cP, or 30 cP to about 50 cP, 40 cP, or 30 cP measured at a shear rate of 511 s⁻¹ after conditioning at 285° F. for 32 hours, and wherein the static viscosity after such conditioning may range from any lower limit to any upper limit and encompasses any subset therebetween. The static viscosity, as described herein, is preferably measured with a R1 rotor, a B1 bob, and a F1 spring (each available from Fann Instrument Co.) at 511 sec⁻¹.

Advantageously, in some embodiments, the static viscosity of viscosified base fluids described herein may reduce over time at wellbore conditions. Such reduction may allow for treatment fluids (e.g., comprising the viscosified base fluid and particulates) to flow back after depositing the particulates in a desired location. To assess the properties of the viscosified base fluids relative to static viscosity reduction, the viscosified base fluids may be conditioned for longer time periods. In some embodiments, the viscosified base fluids described herein may have a static viscosity of about 10 cP or less at a shear rate of 511 s⁻¹ after conditioning at 285° F. for 48 hours. In some embodiments, the viscosified base fluids described herein may have a static viscosity ranging from a lower limit of about 1 cP, 2 cP, or 3 cP to an upper limit of about 10 cP, 8 cP, or 5 cP measured at a shear rate of 511 s⁻¹ after conditioning at 285° F. for 48 hours, and wherein the static viscosity after such conditioning may range from any lower limit to any upper limit and encompasses any subset therebetween.

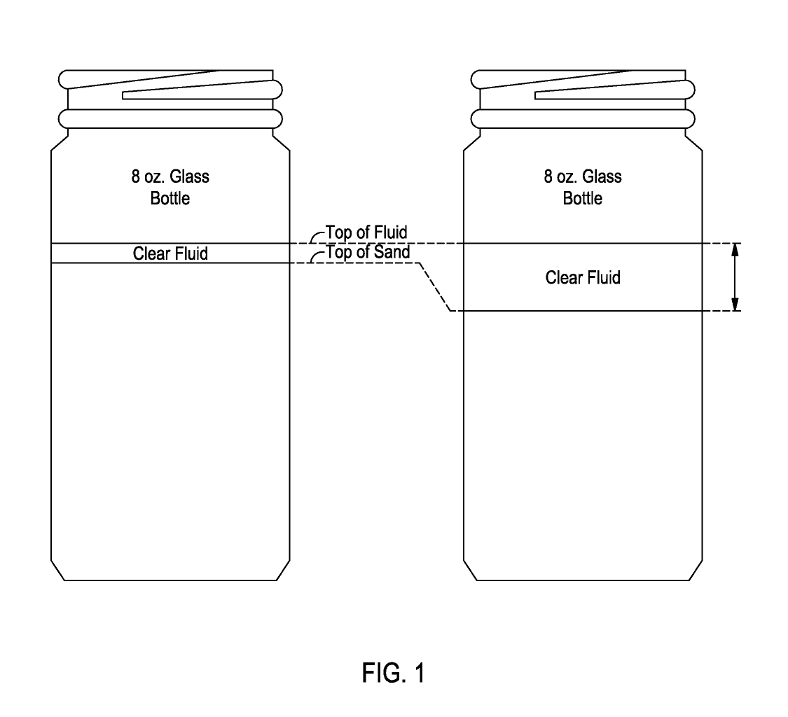

As used herein, the particulate settling value refers to the percent of fluid from which the particulates settle as measured by preparing 100 mL of the viscosified base fluid, adding 20/40 sand to the viscosified base fluid at a 6 ppg load while stirring, placing the viscosified base fluid with particulates in a glass cylinder, exposing the resultant fluid to 500 psi and 285° F. for 30 minutes (e.g., in an autoclave), measuring the volume of the sand free fluid (or clear fluid) at the top of the fluid, and calculating the particulate settling value as the (sand free fluid volume)/(total sample volume)*100. FIG. 1 provides an illustration of two jars having different samples that have different particulate settling values of 8% for the jar on the left and 20% for the jar on the right. The height of the clear fluid is used to calculate the sand free fluid volume for calculating the particulate settling value.

In some embodiments, the viscosified base fluids described herein may have a particulate settling value of about 20% or less after conditioning at 285° F. for 30 minutes. In some embodiments, the viscosified base fluids described herein may have a particulate settling value ranging from a lower limit of about 0%, 2%, or 5% to an upper limit of about 20% 15%, 10%, or 5% after conditioning at 285° F. for 30 minutes, and wherein the particulate settling value after such conditioning may range from any lower limit to any upper limit and encompasses any subset therebetween.

In some embodiments, the viscosified base fluids described herein may have at least two of the foregoing fluid properties. For example, a viscosified base fluid described herein may have a static viscosity of about 15 cP to about 50 cP measured at a shear rate of 511 s⁻¹ after conditioning at 285° F. for 32 hours and a static viscosity of about 1 cP to about 5 cP measured at a shear rate of 511 after conditioning at 285° F. for 48 hours. In another example, a viscosified base fluid described herein may have an apparent viscosity of about 100 cP to about 225 cP at a shear rate of 100 s⁻¹ after conditioning at 285° F. for 16 hours, a static viscosity of about 10 cP to about 30 cP measured at a shear rate of 511 s⁻¹ after conditioning at 285° F. for 32 hours, and a particulate settling value of about 10% or less after conditioning at 285° F. for 30 minutes.

Aqueous viscosified base fluids suitable for use in the viscosified base fluids described herein may comprise fresh water, saltwater (e.g., water containing one or more salts dissolved therein), brackish water, brine (e.g., saturated salt water), seawater, or any combination thereof. Generally, the water may be from any source, provided that it does not contain components that might adversely affect the stability and/or performance of the viscosified base fluids described herein. In certain embodiments, the pH of the aqueous viscosified base fluid may be adjusted (e.g., by a buffer or other pH adjusting agent), among other purposes, to activate a crosslinking agent and/or to reduce the viscosity of the viscosified base fluid (e.g., activate a breaker or deactivate a crosslinking agent). In these embodiments, the pH may be adjusted to a specific level, which may depend on, among other factors, the types of gelling agents, acids, and other additives included in the viscosified base fluid. One of ordinary skill in the art, with the benefit of this disclosure, will recognize when such density and/or pH adjustments are appropriate. In some embodiments, the pH range may preferably be from about 4 to about 11.

In some embodiments, the salt may be useful in achieving the desired density of the viscosified base fluid. Suitable salts may include, but are not limited to, cesium formate, calcium bromide, calcium chloride, and the like, and any combination thereof. By way of nonlimiting example, a viscosified base fluid may comprise a mixture of cesium formate, calcium bromide, and calcium chloride.

Oxygen scavengers suitable for use in the viscosified base fluids described herein may include, but are not limited to, sodium thiosulfate, an alkali metal thiosulfate, sodium dithionite, disodium phosphate, sodium sulfite, zinc sulfite, hydroquinone, hydrazine, diethylhydroxylamine, carbohydrazide, and any combination thereof.

In some embodiments, the viscosified base fluids described herein may include the oxygen scavengers at a concentration ranging from a lower limit of about 10 lb/Mgal, 15 lb/Mgal, 20 lb/Mgal, or 30 lb/Mgal to an upper limit of about 60 lb/Mgal, 50 lb/Mgal, or 40 lb/Mgal, and wherein the concentration may range from any lower limit to any upper limit and encompasses any subset therebetween.

Gelling agents suitable for use in the viscosified base fluids described herein may be biopolymer, synthetic polymers, or a combination thereof. Examples of biopolymer gelling agents include, but are not limited to, diutan, xanthan, a guar gum, hydroxyethyl guar, hydroxypropyl guar, carboxymethyl guar, carboxymethylhydroxyethyl guar, carboxymethylhydroxypropyl guar (“CMHPG”), a cellulose derivative, hydroxyethyl cellulose, carboxyethylcellulose, carboxymethylcellulose, carboxymethylhydroxyethylcellu lose, scleroglucan, succinoglycan, welan, any derivative thereof, and any combination thereof. Examples of synthetic gelling agents may be homopolymers or copolymers with monomeric units that include, but are not limited to, acrylamide ethyltrimethyl ammonium chloride, acrylamide, acrylamido-alkyl trialkyl ammonium salts, methacrylamido-alkyl trialkyl ammonium salts, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacry late, partially hydrolyzed acrylamide, 2-amino-2-methyl propane sulfonic acid, vinyl alcohol, sodium 2-acrylamido-2-methylpropane sulfonate, quaternized dimethylaminoethylacrylate, any derivative thereof, and any combination thereof. As used herein, the term “copolymer” encompasses polymers with two or more monomeric units, e.g., alternating copolymers, statistic copolymers, random copolymers, periodic copolymers, block copolymers (e.g., diblock, triblock, and so on), terpolymers, graft copolymers, branched copolymers, star polymers, and the like, or any hybrid thereof. In some embodiments, the gelling agents may be linear polymers or linear copolymers.

In some embodiments, the viscosified base fluids described herein may include the gelling agents at a concentration ranging from a lower limit of about 30 lb/Mgal, 40 lb/Mgal, or 50 lb/Mgal to an upper limit of about 80 lb/Mgal, 70 lb/Mgal, or 60 lb/Mgal, and wherein the concentration may range from any lower limit to any upper limit and encompasses any subset therebetween.

In some embodiments, the viscosified base fluids described herein may further comprise a crosslinking agent. Crosslinking agents suitable for use in the viscosified base fluids described herein may include, but are not limited to, borate ions, magnesium ions, zirconium IV ions, titanium IV ions, aluminum ions, antimony ions, chromium ions, iron ions, copper ions, magnesium ions, and zinc ions. These ions may be provided by providing any compound that is capable of producing one or more of these ions. Examples of such compounds include, but are not limited to, ferric chloride, boric acid, disodium octaborate tetrahydrate, sodium diborate, pentaborates, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, and titanium acetylacetonate, aluminum lactate, aluminum citrate, antimony compounds, chromium compounds, iron compounds, copper compounds, zinc compounds, and any combination thereof.

When included, suitable crosslinking agents may be at a concentration sufficient to provide the desired degree of crosslinking between molecules of the gelling agent. In some embodiments, the viscosified base fluids described herein may include the crosslinking agents at a concentration ranging from a lower limit of about 0.005%, 0.05%, or 0.1% by weight of the viscosified base fluid to an upper limit of about 7%, 5%, 3%, 1%, 0.5%, or 0.1% by weight of the viscosified base fluid, and wherein the concentration may range from any lower limit to any upper limit and encompasses any subset therebetween. One of ordinary skill in the art, with the benefit of this disclosure, will recognize the appropriate amount of crosslinking agent to include in a viscosified base fluid described herein may depend on, among other things, the temperature conditions of a particular application, the type of gelling agents used, the molecular weight of the gelling agents, the desired degree of viscosification, the pH of the viscosified base fluid, and a combination thereof.

In some embodiments, the viscosified base fluids described herein may further comprise additives. Additives suitable for use in conjunction with the viscosified base fluids described herein may include, but are not limited to, a weighting agent, an inert solid, a fluid loss control agent, an emulsifier, a dispersion aid, a corrosion inhibitor, an emulsion thinner, an emulsion thickener, a surfactant, a viscoelastic surfactant, a lost circulation material, a pH control additive, a breaker, a biocide, a crosslinker, a stabilizer, a chelating agent, a scale inhibitor, a gas hydrate inhibitor, a mutual solvent, a friction reducer, a clay stabilizing agent, and the like, and any combination thereof.

In some embodiments, the viscosified base fluids described herein may include additives at a concentration of about 0.01%, 0.05%, 0.1%, or 1% by weight of the viscosified base fluid to an upper limit of about 10%, 5%, or 2% by weight of the viscosified base fluid, and wherein the concentration may range from any lower limit to any upper limit and encompasses any subset therebetween. One of ordinary skill in the art should understand the appropriate additives and concentration thereof so as to minimally effect the desired fluid properties described herein. For example, in some embodiments, the viscosified base fluids described herein may not comprise a breaker. Rather, the viscosified base fluids described herein may, in some embodiments, break from exposure to the temperatures and pressure downhole. In other embodiments, the viscosified base fluids described herein may comprise breakers (or breakers and stabilizers in the appropriate relative concentrations) to achieve the desired fluid properties described herein.

As discussed above, the viscosified base fluids described herein may be useful in transporting particulates. In some embodiments, a treatment fluid may comprise a viscosified base fluid described herein and a plurality of particulates (e.g., gravel particulates, proppant particulates, or both). Particulates suitable for use in the treatment fluids described herein may comprise any material suitable for use in a subterranean formation. Examples of such materials include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and any combination thereof.

The mean particulate size generally may range from about 2 mesh to about 400 mesh on the U.S. Sieve Series; however, in certain circumstances, other mean particulate sizes may be desired and will be entirely suitable for practice of the present invention. In particular embodiments, preferred mean particulates size distribution ranges are one or more of 6/12, 8/16, 12/18, 12/20, 16/30, 20/40, 30/50, 40/60, 40/70, or 50/70 mesh. It should be understood that the term “particulate,” as used in this disclosure, includes all known shapes of materials, including substantially spherical materials, fibrous materials, polygonal materials (such as cubic materials), and combinations thereof.

In some embodiments, the treatment fluids described herein may include the particulates at a concentration ranging from a lower limit of about 0.5 ppg, 1 ppg, 5 ppg, or 10 ppg to an upper limit of about 30 ppg, 20 ppg, or 10 ppg, and wherein the concentration may range from any lower limit to any upper limit and encompasses any subset therebetween.

Some embodiments of the present invention may involve forming a particulate pack (e.g., a gravel pack, a proppant pack, or the like) in a wellbore penetrating a subterranean formation, the subterranean formation, or a combination thereof. The wellbore proximal to the particulate pack may be cased or uncased. As used herein, the term “wellbore” encompasses both cased wellbores and uncased wellbores (including wellbores where a portion is cased and another portion is uncased), unless otherwise specified.

In some instances, the particulate pack may be placed or formed in conjunction with (e.g., proximal to) a sand control screen assembly. In some embodiments, a sand control screen assembly may comprise alternate flow paths (e.g., shunt tubes and bypass conduits).

Some embodiments may involve introducing a treatment fluid comprising a viscosified base fluid described herein and a plurality of particulates into a wellbore penetrating a subterranean formation; and forming a particulate pack in the wellbore, the subterranean formation, or a combination thereof. In some embodiments, the particulate pack may be a gravel pack. In some embodiments, the particulate pack may be a proppant pack.

Some embodiments may involve providing a sand control screen assembly disposed within a wellbore penetrating a subterranean formation; and forming a gravel pack proximal to the sand control screen assembly with a treatment fluid, wherein the treatment fluid comprises a viscosified base fluid described herein and a plurality of particulates. In some instances, the sand control screen assembly comprises alternate flow paths.

In some embodiments, providing a sand control screen assembly may involve placing a sand control screen assembly in the wellbore.

Some embodiments may involve placing a sand control screen assembly in a wellbore penetrating a subterranean formation, the wellbore having drilling fluid disposed therein; displacing the drilling fluid with a displacement fluid, the displacement fluid comprising a first viscosified base fluid described herein; and forming a gravel pack proximal to the sand control screen assembly with a treatment fluid, the treatment fluid comprising a second viscosified base fluid described herein and a plurality of particulates. In some embodiments, the first viscosified base fluid and the second viscosified base fluid may be the same composition.

Some embodiments may involve introducing a treatment fluid comprising a viscosified base fluid described herein and a plurality of particulates into a wellbore penetrating a subterranean formation, where the treatment fluid passes through a wellbore tool that comprises alternate flow paths; and forming a particulate pack in the wellbore, the subterranean formation, or a combination thereof. Examples of such wellbore tools may include, but are not limited to, a sand control screen assembly, a packer, a completion tool, and a bridge plug.

In some embodiments, the methods described herein may be performed in conjunction with wellbores having a bottom hole static temperature of about 175° F. or greater, about 250° F. or greater, or about 285° F. or greater (e.g., about 285° F. to about 500° F.

In some embodiments, the viscosified base fluids described herein may be utilized to carry particulates from a wellbore or other tubing. For example, cleaning a wellbore or tubing may involve passing a viscosified base fluid described herein through a coiled tubing apparatus that comprises nozzles, so as to dislodge particulates from an inner surface of the wellbore or the tubing; and transporting the viscosified base fluid comprising the dislodged particulates out of the wellbore or the tubing.

Embodiments disclosed herein include:

A. a method that involves providing a sand control screen assembly disposed within a wellbore penetrating a subterranean formation; and forming a gravel pack proximal to the sand control screen assembly with a treatment fluid, wherein the treatment fluid comprises a viscosified base fluid and a plurality of particulates, the viscosified base fluid having a density of about 14 ppg to about 20 ppg and comprises an aqueous fluid, a salt, a gelling agent, and an oxygen scavenger;

B. a method that involves forming a particulate pack in a subterranean formation, a wellbore penetrating the subterranean formation, or both with a treatment fluid, wherein the treatment fluid comprises a plurality of particulates and a viscosified base fluid, the viscosified base fluid having a density of about 14 ppg to about 20 ppg and comprising a brine, a gelling agent, and an oxygen scavenger;

C. a method that involves placing a sand control screen assembly in an uncased wellbore penetrating a subterranean formation, the sand control screen assembly comprising alternate flow paths, and the uncased wellbore having drilling fluid disposed therein; displacing the drilling fluid with a displacement fluid, the displacement fluid comprises a first viscosified base fluid having a density of about 14 ppg to about 20 ppg and comprising a brine, a gelling agent, and an oxygen scavenger; and forming a gravel pack proximal to the sand control screen assembly with a treatment fluid, wherein the treatment fluid comprises a plurality of particulates and a second viscosified base fluid, the second viscosified base fluid having a density of about 14 ppg to about 20 ppg and comprising a brine, a gelling agent, and an oxygen scavenger;

D. a treatment fluid that includes a plurality of particulates; a viscosified base fluid that comprises an aqueous fluid, a salt, a gelling agent, and an oxygen scavenger; wherein the viscosified base fluid has a density of about 14 ppg to about 20 ppg; and wherein the viscosified base fluid has at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 10 cP or less measured at a shear rate of 511 s⁻¹ after conditioning at 285° F. for 48 hours, and (4) a particulate settling value of about 20% or less after conditioning at 285° F. for 30 minutes.

Each of embodiments A, B, and C may have one or more of the following additional elements in any combination: Element 1: the sand control screen assembly having alternate flow paths; Element 2: the sand control screen assembly having alternate flow paths that include a shunt tube; and Element 3: the wellbore having a bottom hole static temperature of about 175° F. to about 500° F.

Each of embodiments A, B, C, and D may have one or more of the following additional elements in any combination: Element 4: the viscosified base fluid having an apparent viscosity of about 50 cP to about 250 cP measured at a shear rate of 100 s⁻¹ after conditioning at 285° F. for 16 hours; Element 5: the viscosified base fluid having a static viscosity of about 10 cP to about 50 cP measured at a shear rate of 511 s⁻¹ after conditioning at 285° F. for 32 hours; Element 6: the viscosified base fluid having a static viscosity of about 10 cP or less measured at a shear rate of 511 s⁻¹ after conditioning at 285° F. for 48 hours; Element 7: wherein the treatment fluid having a particulate settling value of about 20% or less after conditioning at 285° F. for 30 minutes; Element 8: the viscosified base fluid having at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 10 cP or less measured at a shear rate of 511 s⁻¹ after conditioning at 285° F. for 48 hours, and (4) a particulate settling value of about 20% or less after conditioning at 285° F. for 30 minutes; Element 9: the brine comprising at least one selected from the group consisting of cesium formate, calcium bromide, calcium chloride, and any combination thereof; Element 10: the viscosified base fluid further comprising a crosslinking agent; Element 11: the gelling agent being linear; Element 12: the gelling agent comprising at least one selected from the group consisting of diutan, xanthan, a guar gum, hydroxyethyl guar, hydroxypropyl guar, carboxymethyl guar, carboxymethylhydroxyethyl guar, CMHPG, a cellulose derivative, hydroxyethyl cellulose, carboxyethylcellulose, carboxymethylcellulose, carboxymethylhydroxyethylcellu lose, scleroglucan, succinoglycan, welan, any derivative thereof, and any combination thereof; Element 13: the gelling agent comprising at least one homopolymer or copolymer that comprises at least one monomeric unit selected from the group consisting of acrylamide ethyltrimethyl ammonium chloride, acrylamide, an acrylamido-alkyl trialkyl ammonium salt, a methacrylamido-alkyl trialkyl ammonium salt, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacry late, partially hydrolyzed acrylamide, 2-amino-2-methyl propane sulfonic acid, vinyl alcohol, sodium 2-acrylamido-2-methylpropane sulfonate, quaternized dimethylaminoethylacrylate, any derivative thereof, and any combination thereof; Element 14: the gelling agent being at a concentration of about 30 lb/Mgal to about 80 lb/Mgal; Element 15: the oxygen scavenger comprising at least one selected from the group consisting of sodium thiosulfate, an alkali metal thiosulfate, sodium dithionite, disodium phosphate, sodium sulfite, zinc sulfite, hydroquinone, hydrazine, diethylhydroxylamine, carbohydrazide, and any combination thereof; Element 16: the oxygen scavenger being at a concentration of about 10 lb/Mgal to about 60 lb/Mgal; Element 17: the particulates being at a concentration of about 0.5 ppg to about 30 ppg; and Element 18: the brine comprising cesium formate, the viscosifying agent comprising diutan, and the oxygen scavenger comprising sodium thiosulfate.

By way of non-limiting example, exemplary combinations applicable to A, B, C, and D include: Element 11 in combination with Element 14; Element 10 in combination with Element 14; Element 14 in combination with Elements 16 and 17; Element 18 in combination with Element 11; Element 18 in combination with Elements 14, 16, and 17; any of the foregoing in combination with one of Elements 4-8. Further, exemplary combinations applicable to A, B, and C include any of the foregoing combination in combination with Element 1, Element 2, Elements 1 and 3, or Elements 2 and 3.

The exemplary viscosified base fluids and treatment fluids disclosed herein may directly or indirectly affect one or more components or pieces of equipment associated with the preparation, delivery, recapture, recycling, reuse, and/or disposal of the disclosed viscosified base fluids and treatment fluids. For example, the disclosed viscosified base fluids and treatment fluids may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary viscosified base fluids and treatment fluids. The disclosed viscosified base fluids and treatment fluids may also directly or indirectly affect any transport or delivery equipment used to convey the viscosified base fluids and treatment fluids to a well site or downhole such as, for example, any transport vessels, conduits, pipelines, trucks, tubulars, and/or pipes used to fluidically move the viscosified base fluids and treatment fluids from one location to another, any pumps, compressors, or motors (e.g., topside or downhole) used to drive the viscosified base fluids and treatment fluids into motion, any valves or related joints used to regulate the pressure or flow rate of the viscosified base fluids and treatment fluids, and any sensors (i.e., pressure and temperature), gauges, and/or combinations thereof, and the like. The disclosed viscosified base fluids and treatment fluids may also directly or indirectly affect the various downhole equipment and tools that may come into contact with the viscosified base fluids and treatment fluids such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

To facilitate a better understanding of the present invention, the following examples of preferred or representative embodiments are given. In no way should the following examples be read to limit, or to define, the scope of the invention.

### EXAMPLES

### Example 1

A 15 ppg viscosified base fluid was prepared by mixing cesium formate, an aqueous fluid, a gelling agent at 60 lb/Mgal, biocides at a total of 0.036 g/L, chelating agents at 1.44 g/L, and buffer at a pH range of 6.5 to 7.5; allowing the mixture to hydrate; and adding 20 gal/Mgal of surfactant. The resultant viscosified base fluid properties were then tested. The particulate settling value of the viscosified base fluid (measured as described above) was about 0%. The static viscosity was about 33 cp at a shear rate of 511 s⁻¹ after conditioning at 285° F. for 32 hours and about 1 cP at a shear rate of 511 s⁻¹ after conditioning at 285° F. for 48 hours. The apparent viscosity was about 157 cP at a shear rate of 100 s⁻¹ after conditioning at 285° F. for 16 hours.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a sand control screen assembly disposed within a wellbore penetrating a subterranean formation; and
forming a gravel pack proximal to the sand control screen assembly with a treatment fluid, wherein the treatment fluid comprises a viscosified base fluid and a plurality of particulates, the viscosified base fluid having a density of about 14 ppg to about 20 ppg and comprises an aqueous fluid, a salt, a gelling agent, and an oxygen scavenger.

2. The method of claim 1, wherein the sand control screen assembly comprises alternate flow paths.

3. The method of claim 2, wherein the alternate flow paths include a shunt tube.

4. The method of claim 1, wherein the viscosified base fluid has an apparent viscosity of about 50 cP to about 250 cP measured at a shear rate of 100 after conditioning at 285° F. for 16 hours.

5. The method of claim 1, wherein the viscosified base fluid has a static viscosity of about 10 cP to about 50 cP measured at a shear rate of 511 s⁻¹ after conditioning at 285° F. for 32 hours.

6. The method of claim 1, wherein the viscosified base fluid has a static viscosity of about 10 cP or less measured at a shear rate of 511 s⁻¹ after conditioning at 285° F. for 48 hours.

7. The method of claim 1, wherein the treatment fluid has a particulate settling value of about 20% or less after conditioning at 285° F. for 30 minutes.

8. The method of claim 1, wherein the viscosified base fluid has at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 10 cP or less measured at a shear rate of 511 s⁻¹ after conditioning at 285° F. for 48 hours, and (4) a particulate settling value of about 20% or less after conditioning at 285° F. for 30 minutes.

9. The method of claim 1, wherein the viscosified base fluid further comprises a crosslinking agent.

10. The method of claim 1, wherein the gelling agent is linear.

11. The method of claim 1, wherein the gelling agent comprises at least one selected from the group consisting of diutan, xanthan, a guar gum, hydroxyethyl guar, hydroxypropyl guar, carboxymethyl guar, carboxymethylhydroxyethyl guar, carboxymethylhydroxypropyl guar, a cellulose derivative, hydroxyethyl cellulose, carboxyethylcellulose, carboxymethylcellulose, carboxymethylhydroxyethylcellulose, scleroglucan, succinoglycan, welan, any derivative thereof, and any combination thereof.

12. The method of claim 1, wherein the gelling agent comprises at least one homopolymer or copolymer that comprises at least one monomeric unit selected from the group consisting of acrylamide ethyltrimethyl ammonium chloride, acrylamide, an acrylamido-alkyl trialkyl ammonium salt, a methacrylamido-alkyl trialkyl ammonium salt, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacry late, partially hydrolyzed acrylamide, 2-amino-2-methyl propane sulfonic acid, vinyl alcohol, sodium 2-acrylamido-2-methylpropane sulfonate, quaternized dimethylaminoethylacrylate, any derivative thereof, and any combination thereof.

13. The method of claim 1, wherein the gelling agent is at a concentration of about 30 lb/Mgal to about 80 lb/Mgal.

14. The method of claim 1, wherein the oxygen scavenger comprises at least one selected from the group consisting of sodium thiosulfate, an alkali metal thiosulfate, sodium dithionite, disodium phosphate, sodium sulfite, zinc sulfite, hydroquinone, hydrazine, diethylhydroxylamine, carbohydrazide, and any combination thereof.

15. The method of claim 1, wherein the oxygen scavenger comprises at least one selected from the group consisting of disodium phosphate, zinc sulfite, hydrazine, diethylhydroxylamine, carbohydrazide, and any combination thereof.

16. The method of claim 1, wherein the oxygen scavenger is at a concentration of about 10 lb/Mgal to about 60 lb/Mgal.

17. The method of claim 1, wherein the particulates are at a concentration of about 0.5 ppg to about 30 ppg.

18. The method of claim 1, wherein the brine comprises cesium formate, the viscosifying agent comprises diutan, and the oxygen scavenger comprises sodium thiosulfate, and wherein the viscosified base fluid has at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 10 cP or less measured at a shear rate of 511 s⁻¹ after conditioning at 285° F. for 48 hours, and (4) a particulate settling value of about 20% or less after conditioning at 285° F. for 30 minutes.

19. A method comprising:
forming a particulate pack in a subterranean formation, a wellbore penetrating the subterranean formation, or both with a treatment fluid, wherein the treatment fluid comprises a plurality of particulates and a viscosified base fluid, the viscosified base fluid having a density of about 14 ppg to about 20 ppg and comprising a brine, a gelling agent, and an oxygen scavenger, wherein the viscosified base fluid has at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 10 cP or less measured at a shear rate of 511 s⁻¹ after conditioning at 285° F. for 48 hours, and (4) a particulate settling value of about 20% or less after conditioning at 285° F. for 30 minutes.

20. A treatment fluid comprising:
a plurality of particulates;
a viscosified base fluid that comprises an aqueous fluid, a salt, a gelling agent, and an oxygen scavenger;
wherein the viscosified base fluid has a density of about 14 ppg to about 20 ppg; and
wherein the viscosified base fluid has at least two properties selected from the group consisting of (1) an apparent viscosity of about 50 cP to about 250 cP measured at a shear rate of 100 s⁻¹ after conditioning at 285° F. for 16 hours, (2) a static viscosity of about 10 cP to about 50 cP measured at a shear rate of 511 s⁻¹ after conditioning at 285° F. for 32 hours, (3) a static viscosity of about 10 cP or less measured at a shear rate of 511 s⁻¹ after conditioning at 285° F. for 48 hours, and (4) a particulate settling value of about 20% or less after conditioning at 285° F. for 30 minutes.
